(19) United States
(12) Patent Application Publication
(10) Pub. No.: US 2021/0389622 A1
(43) Pub. Date: Dec. 16, 2021

(54) DISPLAY DEVICE AND SPLICING DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Yong FAN, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 16/968,457

(22) PCT Filed: Jul. 10, 2020
(86) PCT No.: PCT/CN2020/101295

§ 371 Date: Aug. 7, 2020

(30) Foreign Application Priority Data
Jun. 11, 2020 (CN) 202010529566.9

(51) Int. Cl. G02F 1/1339; G02F 1/1362; G02F 1/1333

(52) U.S. Cl. CPC G02F 1/13394; G02F 1/13336; G02F 1/136286

(57) ABSTRACT

A display device and a splicing device are provided. The display device includes a backlight module, a display panel, and a driving module. The display panel includes an array substrate. The array substrate includes a first base substrate and an array structure layer. The array structure layer includes an array driving portion and a data transmission portion. Portions of the array driving portion and the data transmission portion close to a side of the first base substrate are perpendicular to each other. The data transmission portion extends along sides of the first base substrate and the backlight module and is electrically connected to the driving module.

### FIELD OF INVENTION

The present invention relates to the field of display technologies, and in particular, to a display device and a splicing device.

### BACKGROUND OF INVENTION

As people's requirements for display effects of display panels gradually increase, how to narrow a width of frames of the display panels and realize seamless display after splicing large-size display panels have become an important development direction.

Current display devices have a problem where that frames are difficult to narrow. Wide frames cause obvious splicing seams when the display panels are spliced into a large-size display panel, which affects display quality.

Therefore, there is an urgent need for a new display device and splicing device to solve the above technical problems.

### Technical Problem

The present invention provides an array substrate, a display device, and a splicing device, which are used to solve a problem that current display panel has an obvious splicing seam when splicing into a large-size display device due to a wide frame, which affects display quality.

### Technical Solution

The present invention provides a display device, comprising a backlight module, a display panel disposed on the backlight module, and a driving module disposed on a side of the backlight module away from an array substrate;

wherein the display panel comprises the array substrate, a liquid crystal layer disposed on the array substrate, and a second substrate disposed on the liquid crystal layer;

wherein the array substrate comprises a first base substrate and an array structure layer disposed on the first base substrate, the array structure layer comprises an array driving portion and a data transmission portion bent to a side of the first base substrate away from the array driving portion;

wherein portions of the array driving portion and the data transmission portion close to a side of the first base substrate are perpendicular to each other; and

wherein the data transmission portion extends along sides of the first base substrate and the backlight module and is electrically connected to the driving module.

In the display device provided by the present invention, the display panel further comprises a retaining wall disposed between the first base substrate and the second substrate;

the retaining wall comprises a first sub-retaining wall disposed along a periphery of the display panel, and a width of the first sub-retaining wall in a first direction is less than a distance between two adjacent pixels of the display panel; and

the first direction is parallel to an extending direction of a scanning line of the display panel.

In the display device provided by the present invention, the retaining wall further comprises a second sub-retaining wall, and the second sub-retaining wall is disposed between the two adjacent pixels and/or two adjacent sub-pixels of the display panel.

In the display device provided by the present invention, in the first direction, a width of the second sub-retaining wall is less than or equal to the distance between the two adjacent pixels of the display panel.

In the display device provided by the present invention, in the first direction, a number of the second sub-retaining walls between the two adjacent pixels of the display panel is greater than or equal to one.

In the display device provided by the present invention, the second sub-retaining wall is disposed around the pixels of the display panel.

In the display device provided by the present invention, the display panel further comprises a black matrix disposed on the array substrate or the second substrate, and

wherein the second sub-retaining wall is integrated with the black matrix.

In the display device provided by the present invention, a material of the retaining wall comprises at least a light curing resin and a light alignment monomer.

In the display device provided by the present invention, the light curing resin is a silicone resin and the light alignment monomer is an aliphatic chlorosilane-containing compound.

In the display device provided by the present invention, the light curing resin is an aliphatic silicone compound and the light alignment monomer is an aliphatic trichlorosilane compound.

In the display device provided by the present invention, the material of the retaining wall further comprises black light-absorbing material.

In the display device provided by the present invention, the first sub-retaining wall comprises a black light-absorbing layer or a reflective layer disposed on a side of the first sub-retaining wall away from the pixels of the display panel.

In the display device provided by the present invention, a material of the first base substrate is colorless polyimide.

In the display device provided by the present invention, the backlight module is an ultra-thin backlight module.

In the display device provided by the present invention, the backlight module comprises a metal plate electrically connected to the driving module, and a light source disposed on a side of the metal plate away from the driving module.

The present invention further provides a splicing device comprising at least two display devices, wherein each display device comprises a backlight module, a display panel disposed on the backlight module, and a driving module disposed on a side of the backlight module away from an array substrate;

wherein the display panel comprises the array substrate, a liquid crystal layer disposed on the array substrate, and a second substrate disposed on the liquid crystal layer;

wherein the array substrate comprises a first base substrate and an array structure layer disposed on the first base substrate, the array structure layer comprises an array driving portion and a data transmission portion bent to a side of the first base substrate away from the array driving portion;

wherein portions of the array driving portion and the data transmission portion close to a side of the first base substrate are perpendicular to each other; and

wherein the data transmission portion extends along sides of the first base substrate and the backlight module and is electrically connected to the driving module;

wherein in the first direction, a width of the first sub-retaining wall between the two adjacent display devices is less than a distance between the two adjacent pixels in the display device.

In the splicing device provided by the present invention, in the first direction, a ration of a width of the first sub-retaining wall between the two adjacent display devices and a sum of a width of the pixel in the display device and the width of the first sub-retaining wall between the two adjacent display devices is greater than 0 and less than or equal to 0.12.

In the splicing device provided by the present invention, in the first direction, the ration of the width of the first sub-retaining wall between the two adjacent display devices and a sum of a width of the pixel in the display device and the width of the first sub-retaining wall between the two adjacent display devices is greater than 0 and less than or equal to 0.1.

### Beneficial Effect

In the present invention, an array driving portion and a data transmission portion are perpendicular to each other, which reduces a width of a non-display region on a side of a display region of a display device, which is beneficial to an elimination of a splicing seam in a large-size display device and improves display quality of the large-size display device.

### DESCRIPTION OF DRAWINGS

The following describes a specific implementation of the present invention in detail with reference to accompanying drawings, which will make technical solutions and other beneficial effects of the present invention obvious.

FIG. 1 is a structural schematic view of a first embodiment of a display device of the present invention.

FIG. 2 is a structural schematic view of a second embodiment of the display device of the present invention.

FIG. 3 is a structural schematic view of a third embodiment of the display device of the present invention.

FIG. 4 is a schematic structural view of a splicing device of the present invention.

### DETAILED DESCRIPTION OF PREFERRED EMBODIMENTS

The present invention provides a display device and a splicing device. In order to make the purpose, technical solutions, and effects of the present invention clearer, the following describes the present invention in further detail with reference to the accompanying drawings and examples. It should be understood that the specific embodiments described herein are only used to explain the present invention and are not used to limit the present invention.

Current display devices have a problem where that a splicing seam is obvious when they are spliced into a large-size display device due to having a wide frame, which affects display quality. Based on this, the present invention provides a display device and a splicing device.

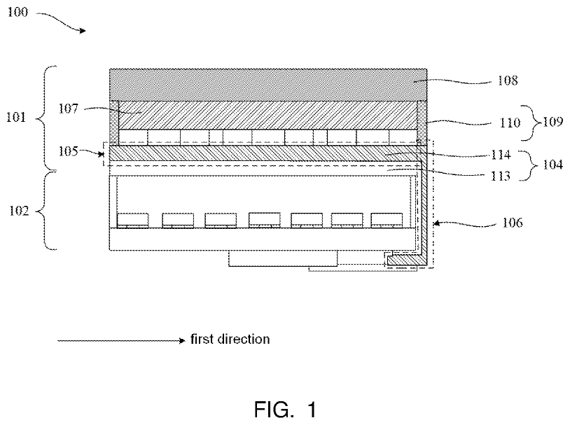

Please refer to FIG. 1 to FIG. 3, the present invention provides a display device 100. The display device 100 comprises a backlight module 102, a display panel 101 disposed on the backlight module 102, and a driving module disposed on a side of the backlight module 102 away from an array substrate 104.

The display panel 101 comprises the array substrate 104, a liquid crystal layer 107 disposed on the array substrate 104, and a second substrate 108 disposed on the liquid crystal layer 107. The array substrate 104 comprises a first base substrate 113 and an array structure layer 114 disposed on the first base substrate 113.

The array structure layer 114 comprises an array driving portion 105 and a data transmission portion 106 bent to a side of the first base substrate 113 away from the array driving portion 105.

Portions of the array driving portion 105 and the data transmission portion 106 close to a side of the first base substrate are perpendicular to each other.

The data transmission portion 106 extends along sides of the first base substrate 113 and the backlight module 102 and is electrically connected to the driving module.

In the embodiment, the backlight module 102 may be a mini LED ultra-thin backlight module, which is beneficial to reduce a thickness of the display device 100, reduce a distance between the backlight module 102 and the liquid crystal layer 107, and reduce risk of side light leakage of the display device 100.

In the embodiment, the backlight module 102 may comprise a metal plate electrically connected to the driving module and a light source disposed on the metal plate away from the driving module. The light source comprises an LED light.

In the embodiment, the backlight module 102 may further comprise structures such as a reflective film, a light guide plate, a diffusion film, and an optical film.

In the embodiment, the display panel 101 may further comprise a color film layer disposed between the array substrate 104 and the liquid crystal layer 107 or between the liquid crystal layer 107 and the second substrate 108.

The color film layer comprises at least a red color resist, a green color resist, and a blue color resist.

In the embodiment, the first base substrate 113 may be a flexible substrate, and a material of the first base substrate 113 may be colorless polyimide.

In the embodiment, the array substrate 104 can be used in a liquid crystal display device or an OLED display device.

In the embodiment, the array driving portion 105 is disposed in a display region of the display device, and the data transmission portion 106 is disposed in a non-display region of the display device.

In the present invention, by bending the data transmission portion 106 of the array substrate 104 to a side of the first base substrate 113 away from the array structure layer 114, the array driving portion 105 and the data transmission portion 106 are perpendicular to each other, which reduces a width of the non-display region on a side of the display region of the display device 100, and is beneficial to an elimination of splicing seams in a large-size display device 100 and improves display quality of the large-size display device 100.

The technical solution of the present invention will now be described in conjunction with specific embodiments.

### First Embodiment

Referring to FIG. 1, the display panel 101 further comprises a retaining wall 109 disposed between the first base substrate 113 and the second substrate 108.

The retaining wall 109 comprises a first sub-retaining wall 110 disposed along a periphery of the display panel 101, and a width of the first sub-retaining wall 110 in a first direction is less than a distance between two adjacent pixels of the display panel 101.

The first direction is parallel to an extending direction of a scanning line of the display panel 101.

In the embodiment, the first sub-retaining wall 110 may comprise a black light-absorbing layer or a reflective layer on a side of the first sub-retaining wall 110 away from the pixels of the display panel 101.

An arrangement of the black light-absorbing layer or the reflective layer on the side of the first sub-retaining wall 110 away from the pixels of the display panel 101 is beneficial to reflect or absorb light from an outside and avoid an interference of the outside light on the display of the display device 100.

In the embodiment, a material of the first sub-retaining wall 110 may comprise a black light-absorbing material.

When the material of the first sub-retaining wall 110 comprises the black light-absorbing material, it can absorb the light from the outside and light from the backlight module 102. This not only helps avoid an external light from interfering with the display of the display device 100, but also avoids the reflection of light from the backlight module 102 through the first sub-retaining wall 110 from affecting a normal display of the display device 100.

In the embodiment, the distance between the two adjacent pixels of the display panel 101 is 160 microns to 300 microns, preferably 175 microns to 275 microns.

When the distance between the two adjacent pixels of the display panel 101 is less than 160 microns, the distance between the two adjacent pixels of the display panel 101 is significantly less than a width of a data line of the display panel 101 in the first direction, causing the data line to affect the display of the display device 100. When the distance between the two adjacent pixels of the display panel 101 is greater than 300 microns, the distance between the two adjacent pixels of the display panel 101 is obviously too large, which affects a resolution of the display device 100 and affects display quality of the display device 100. When the distance between the two adjacent pixels of the display panel 101 is 175 microns to 275 microns, it can completely avoid the data line from affecting the display of the display device 100 and can also avoid reduction of the resolution of the display device 100.

The embodiment replaces a traditional sealant by an arrangement of the first sub-retaining wall 110. While sealing the display device 100, it is advantageous to narrow a frame of the display device 100, realize seamless display of the large-sized display device formed by splicing, and improve the display quality of the large-sized display device.

### Second Embodiment

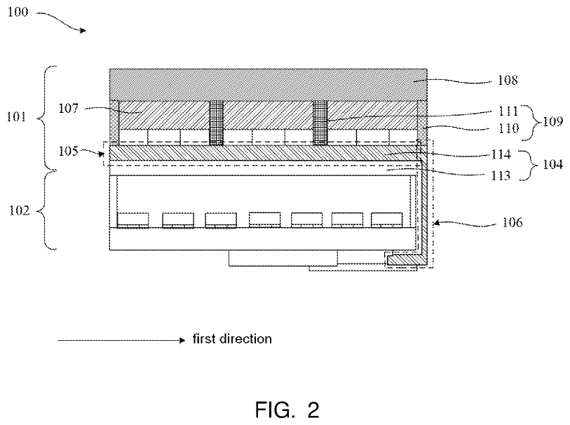

Please refer to FIG. 2, the embodiment is the same as or similar to the first embodiment, and a difference is that:

The retaining wall 109 further comprises a second sub-retaining wall 111, and the second sub-retaining wall 111 is disposed between the two adjacent pixels and/or two adjacent sub-pixels of the display panel 101.

In the embodiment, the second sub-retaining wall 111 is disposed between the array structure layer 114 of the array substrate 104 and the second substrate 108.

In the embodiment, the second sub-retaining wall 111 may be disposed between two adjacent pixels of the display panel 101.

When the second sub-retaining wall 111 is disposed between the two adjacent pixels of the display panel 101 in the first direction, a width of the second sub-retaining wall 111 is less than or equal to the distance between two adjacent pixels of the display panel 101.

When the second sub-retaining wall 111 is disposed between the two adjacent pixels of the display panel 101 in the first direction, the number of the second sub-retaining wall 111 may be one or more than one.

In the embodiment, the second sub-retaining wall 111 may be disposed between the two adjacent sub-pixels of the display panel 101.

In the embodiment, the second sub-retaining wall 111 may be disposed between the two adjacent pixels of the display panel 101 and between the two adjacent sub-pixels of the display panel 101.

In the embodiment, the second sub-retaining wall 111 may be disposed around the pixels of the display panel 101.

In the embodiment, a material of the second sub-retaining wall 111 may include a black light-absorbing material.

When the material of the second sub-retaining wall 111 comprises the black light-absorbing material, it is beneficial to absorb the light from the backlight module 102, to avoid the reflection of the light from the backlight module 102 through the second sub-retaining wall 111, and avoid causing interference to the normal display of the display device 100.

In the embodiment, by an arrangement of the second sub-retaining wall 111, and the second sub-retaining wall 111 is disposed between the two adjacent pixels and/or the two adjacent sub-pixels of the display panel 101, it is beneficial to avoid large-area leakage of the liquid crystal layer 107. Especially when the display panel 101 is bent, due to an existence of the second sub-retaining wall 111 between the array substrate 104 and the second substrate 108, not only does it play a supporting role, but also prevents leakage problems caused by external stresses enacted on the liquid crystal layer 107, and improves product quality of the display device 100.

### Third Embodiment

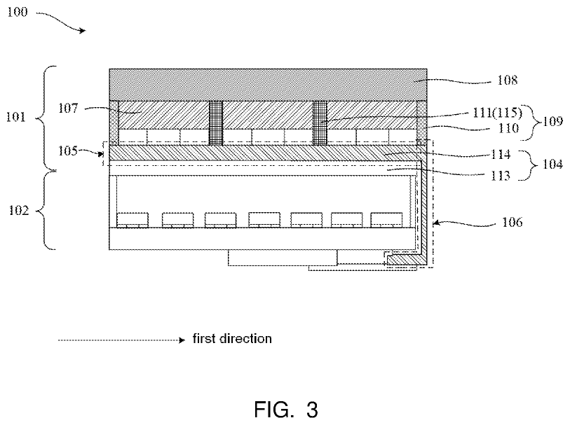

Please refer to FIG. 3, the embodiment is the same as or similar to the first and second embodiments, except for the following:

The display panel 101 further comprises a black matrix 115 disposed on the array substrate 104 or the second substrate 108.

The second sub-retaining wall 111 is integrated with the black matrix 115.

In the embodiment, the second sub-retaining wall 111 and the black matrix 115 can be formed in a same process and with a same material.

In the embodiment, the black matrix 115 may be disposed on the color film layer. When the color film layer is disposed on the array substrate 104, the black matrix 115 may also be separately disposed on a side of the second substrate 108 close to the liquid crystal layer 107.

In the embodiment, when the second sub-retaining wall 111 and the black matrix 115 are integrally disposed, the width of the second sub-retaining wall 111 in the first direction may be the same as the distance between the two adjacent pixels of the display panel 101.

In the embodiment, the second sub-retaining wall 111 and the black matrix 115 are integrally disposed, and the second sub-retaining wall 111 can be formed by the same process and the same material as the black matrix 115, thereby simplifying formation steps of the display device 100.

In the above embodiments, a material of the retaining wall 109 may comprise at least a light curing resin and a light alignment monomer. The light curing resin may be silicone resins such as aliphatic silicone compounds, etc., and the light alignment monomer may be aliphatic chlorine-containing silane compounds such as an aliphatic trichlorosilane compound, etc. The light alignment monomer can be used to assist an alignment of the liquid crystal molecules of the liquid crystal layer 107. A replacement of a traditional frame glue by the retaining wall 109 prevents a problem that the traditional frame glue easily falls off during cutting, resulting in inadequate sealing of the display device and the leakage of liquid crystals, and coupled with precise waterjet cutting technology, it is conducive to the effective narrowing of the frame of the display panel 101.

The above embodiments all provide the retaining wall 109 to seal the display device 100 and help to narrow the frame of the display device 100 to achieve seamless display of the large-sized display device formed by splicing and improve the display quality of the large-sized display device.

In the above embodiments, by bending the data transmission portion 106 of the array substrate 104 to the side of the first base substrate 113 away from the array structure layer 114, the array driving portion 105 and the data transmission portion 106 are perpendicular to each other, which reduces the width of the non-display region on the side of the display region of the display device, improves a screen ratio, and facilitates the elimination of splicing seams in the large-size display device and improves the display quality of the large-size display device.

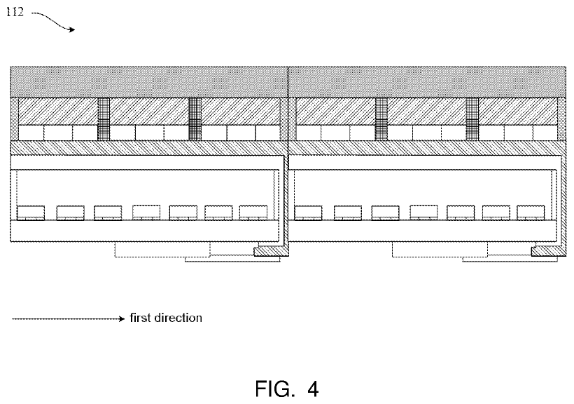

Please refer to FIG. 4, the present invention further provides a splicing device. The splicing device comprises at least two display devices 100 as described above.

In the first direction, the width of the first sub-retaining wall 110 between the two adjacent display devices 100 is less than the distance between the two adjacent pixels in the display device 100.

In the embodiment, in the first direction, a ratio of the width of the first sub-retaining wall 110 between two adjacent display devices 100 and a sum of a width of a pixel in the display device 100 and the width of the first sub-retaining wall 110 between the two adjacent display devices 100 is greater than 0 and less than or equal to 0.12, preferably greater than 0 and less than or equal to 0.1.

When the ratio of the width of the first sub-retaining wall 110 between the two adjacent display devices 100 and the sum of the width of the pixel in the display device 100 and the width of the first sub-retaining wall 110 between the two adjacent display devices 100 is greater than 0.12, the width of the first sub-retaining wall 110 in the first direction is too large, resulting in a clearly noticeable splicing seam between the two adjacent display devices 100. When the ratio of the width of the first sub-retaining wall 110 between the two adjacent display devices 100 and the sum of the width of the pixel in the display device 100 and the width of the first sub-retaining wall 110 between the two adjacent display devices 100 is greater than 0 and less than or equal to 0.1, the width of the first sub-retaining wall 110 in the first direction is significantly smaller than the width of the pixel in the first direction, which is beneficial to completely eliminate the splicing seam between the two adjacent display devices 100 when the splicing device 112 is displayed.

In the embodiment, a specific structure of the display device 100 included in the splicing device 112 has been specifically described in the description of the foregoing display device, and will not be repeated here.

In the splicing device 112 provided by the present invention, the data transmission portion 106 of the array substrate 104 of the display device 100 by splicing is bent until the first base substrate 113 is away from the side of the array structure layer 114, the array driving portion 105 and the data transmission portion 106 are perpendicular to each other, reducing the width of the non-display region on the side of the display region of the display device 100. In addition, the display device 100 is sealed through the arrangement of the retaining wall 109, which is conducive to narrowing the frame of the display device 100, achieving a seamless display of the large-sized display device formed by splicing, and improving the display quality of large-sized display devices.

The present invention provides the display device and the splicing device. The display device comprises the backlight module, the display panel disposed on the backlight module, and the driving module disposed on the side of the backlight module away from an array substrate. The display panel comprises the array substrate. The array substrate comprises the first base substrate and the array structure layer disposed on the first base substrate. The array structure layer comprises the array driving portion and the data transmission portion bent to the side of the first base substrate away from the array driving portion. The portions of the array driving portion and the data transmission portion close to the side of the first base substrate are perpendicular to each other. The data transmission portion extends along sides of the first base substrate and the backlight module and is electrically connected to the driving module. In the present invention, the array driving portion and the data transmission portion are perpendicular to each other, which reduces the width of the non-display region on the side of the display region of the display device, and is beneficial to the elimination of the splicing seam in large-size display devices and improves the display quality of large-size display devices.

It can be understood that, for those of ordinary skill in the art, equivalent replacements or changes can be made according to the technical solutions and inventive concepts of the present invention, and all such changes and modifications are within the scope of the claims of the present invention.

1. A display device, comprising:
a backlight module, a display panel disposed on the backlight module, and a driving module disposed on a side of the backlight module away from an array substrate;
wherein the display panel comprises the array substrate, a liquid crystal layer disposed on the array substrate, and a second substrate disposed on the liquid crystal layer; and
wherein the array substrate comprises a first base substrate and an array structure layer disposed on the first base substrate, the array structure layer comprises an array driving portion and a data transmission portion bent to a side of the first base substrate away from the array driving portion;
wherein portions of the array driving portion and the data transmission portion close to the side of the first base substrate are perpendicular to each other; and
wherein the data transmission portion extends along the sides of the first base substrate and the backlight module and is electrically connected to the driving module.

2. The display device as claimed in claim 1, wherein the display panel further comprises a retaining wall disposed between the first base substrate and the second substrate;
the retaining wall comprises a first sub-retaining wall disposed along a periphery of the display panel, and a width of the first sub-retaining wall in a first direction is less than a distance between two adjacent pixels of the display panel; and
the first direction is parallel to an extending direction of a scanning line of the display panel.

3. The display device as claimed in claim 2, wherein the retaining wall further comprises a second sub-retaining wall, and the second sub-retaining wall is disposed between the two adjacent pixels and/or two adjacent sub-pixels of the display panel.

4. The display device as claimed in claim 3, wherein in the first direction, a width of the second sub-retaining wall is less than or equal to the distance between the two adjacent pixels of the display panel.

5. The display device as claimed in claim 4, wherein in the first direction, a number of the second sub-retaining walls between the two adjacent pixels of the display panel is greater than or equal to one.

6. The display device as claimed in claim 3, wherein the second sub-retaining wall is disposed around the pixels of the display panel.

7. The display device as claimed in claim 3, wherein the display panel further comprises a black matrix disposed on the array substrate or the second substrate, and the second sub-retaining wall is integrated with the black matrix.

8. The display device as claimed in claim 2, wherein a material of the retaining wall comprises at least a light curing resin and a light alignment monomer.

9. The display device as claimed in claim 8, wherein the light curing resin is a silicone resin and the light alignment monomer is an aliphatic chlorosilane-containing compound.

10. The display device as claimed in claim 9, wherein the light curing resin is an aliphatic silicone compound and the light alignment monomer is an aliphatic trichlorosilane compound.

11. The display device as claimed in claim 2, wherein the material of the retaining wall further comprises black light-absorbing material.

12. The display device as claimed in claim 2, wherein the first sub-retaining wall comprises a black light-absorbing layer or a reflective layer disposed on a side of the first sub-retaining wall away from the pixels of the display panel.

13. The display device as claimed in claim 2, wherein a distance between the two adjacent pixels of the display panel is 160 microns to 300 microns.

14. The display device as claimed in claim 13, wherein the distance between two adjacent pixels of the display panel is 175 microns to 275 microns.

15. The display device as claimed in claim 1, wherein a material of the first base substrate is colorless polyimide.

16. The display device as claimed in claim 1, wherein the backlight module is an ultra-thin backlight module.

17. The display device as claimed in claim 16, wherein the backlight module comprises a metal plate electrically connected to the driving module, and a light source disposed on a side of the metal plate away from the driving module.

18. A display system, comprising:
at least two display devices, wherein each display device comprises a backlight module, a display panel disposed on the backlight module, and a driving module disposed on a side of the backlight module away from an array substrate;
wherein the display panel comprises the array substrate, a liquid crystal layer disposed on the array substrate, and a second substrate disposed on the liquid crystal layer;
wherein the array substrate comprises a first base substrate and an array structure layer disposed on the first base substrate, the array structure layer comprises an array driving portion and a data transmission portion bent to a side of the first base substrate away from the array driving portion;
wherein portions of the array driving portion and the data transmission portion close to the side of the first base substrate are perpendicular to each other;
wherein the data transmission portion extends along sides of the first base substrate and the backlight module and is electrically connected to the driving module; and
wherein in the first direction, a width of the first sub-retaining wall between the two adjacent display devices is less than a distance between the two adjacent pixels in the display device.

19. The display system as claimed in claim 18, wherein in the first direction, a ration of the width of the first sub-retaining wall between the two adjacent display devices, and a sum of a width of a pixel in the display device and the width of the first sub-retaining wall between the two adjacent display devices is greater than 0 and less than or equal to 0.12.

20. The display system as claimed in claim 19, wherein in the first direction, the ration of the width of the first sub-retaining wall between the two adjacent display devices, and the sum of the width of the pixel in the display device and the width of the first sub-retaining wall between the two adjacent display devices is greater than 0 and less than or equal to 0.1.
